(19) United States
(12) Patent Application Publication
(10) Pub. No.: US 2007/0137626 A1
(43) Pub. Date: Jun. 21, 2007

(54) Engine supercharging system

(76) Inventor: David Turner, Bloomfield Hills, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/314,136

(22) Filed: Dec. 21, 2005

(51) Int. Cl. F02B 33/00

(52) U.S. Cl. 123/559.1; 123/559.3

(57) ABSTRACT

A supercharging system for an engine includes an air pump, an electrical machine, an engine-connected input member and a variable-ratio power transmission mechanism. The power transmission mechanism includes a sun member operatively connected to one of the air pump, the electrical machine and the input member. At least one planet member is drivingly interfaced with the sun member and rotatably carried by a carrier operatively connected to another one of the air pump, the electrical machine and the input member. An annulus is drivingly interfaced with the at least one planet member and operatively connected to the other one of the air pump, the electrical machine and the input member. The supercharging system also includes a brake configured to selectively inhibit rotation of at least one of the sun member, the carrier, and the annulus.

### BACKGROUND

Engine downsizing has become an increasingly popular option for automotive manufacturers looking to reduce average carbon dioxide emissions and improve fuel consumption. Unfortunately, the torque produced by a smaller engine can be markedly less than that of a larger one, and while end consumers might accept the reduced emissions and improved fuel economy of a reduced-displacement engine, they often demand the same driving performance and comfort of a larger-displacement engine.

One solution is to pair a reduced-displacement engine with a turbocharger. Turbochargers, which get their power from the flowing exhaust gases produced by internal combustion, are a thermodynamically efficient boosting system, but under some conditions may suffer from lag as the exhaust flow builds to the point where effective boost can be delivered. As engine specific outputs increase, this effect is magnified, limiting the downsizing and carbon dioxide reduction potential offered by conventional turbocharging. Vehicle manufacturers commonly adopt shorter transmission ratios to mitigate this effect; however, this generally has an opposite effect to engine displacement downsizing on carbon dioxide emissions performance.

Another option that overcomes the limitations of turbocharging is pairing a reduced-displacement engine with a supercharger mechanically driven by the engine's crankshaft. Although turbo lag may be overcome with the use of a supercharger, conventional superchargers typically have lower compressor efficiency than turbochargers, and cause significant parasitic losses when boost is not required, potentially harming fuel economy and increasing carbon dioxide emissions.

### SUMMARY

A supercharging system for an engine is provided that includes an air pump, an electrical machine, an engine-connected input member and a variable-ratio power transmission mechanism. The power transmission mechanism includes a sun member operatively connected to one of the air pump, the electrical machine and the input member. At least one planet member is drivingly interfaced with the sun member and rotatably carried by a carrier operatively connected to another one of the air pump, the electrical machine and the input member. An annulus is drivingly interfaced with the at least one planet member and operatively connected to the other one of the air pump, the electrical machine and the input member. The supercharging system also includes a brake configured to selectively inhibit rotation of at least one of the sun member, the carrier, and the annulus.

### BRIEF DESCRIPTION OF THE DRAWINGS

Embodiments of the invention will now be described, by way of example, with reference to the accompanying drawings, wherein:

FIG. 1 is a schematic illustration of an engine supercharging system according to an embodiment of the present invention;

FIG. 2 is a schematic illustration of an engine supercharging system according to another embodiment of the present invention;

FIG. 3 is a graphical illustration of exemplary operating parameters for the engine supercharging system of FIG. 1;

FIG. 4 is a graphical illustration of exemplary operating parameters for the engine supercharging system of FIG. 2;

FIG. 5 is a schematic illustration of a control system for use with an engine supercharging system according to an embodiment of the present invention; and

FIG. 6 is a schematic illustration of a control system for use with an engine supercharging system according to another embodiment of the present invention.

### DETAILED DESCRIPTION

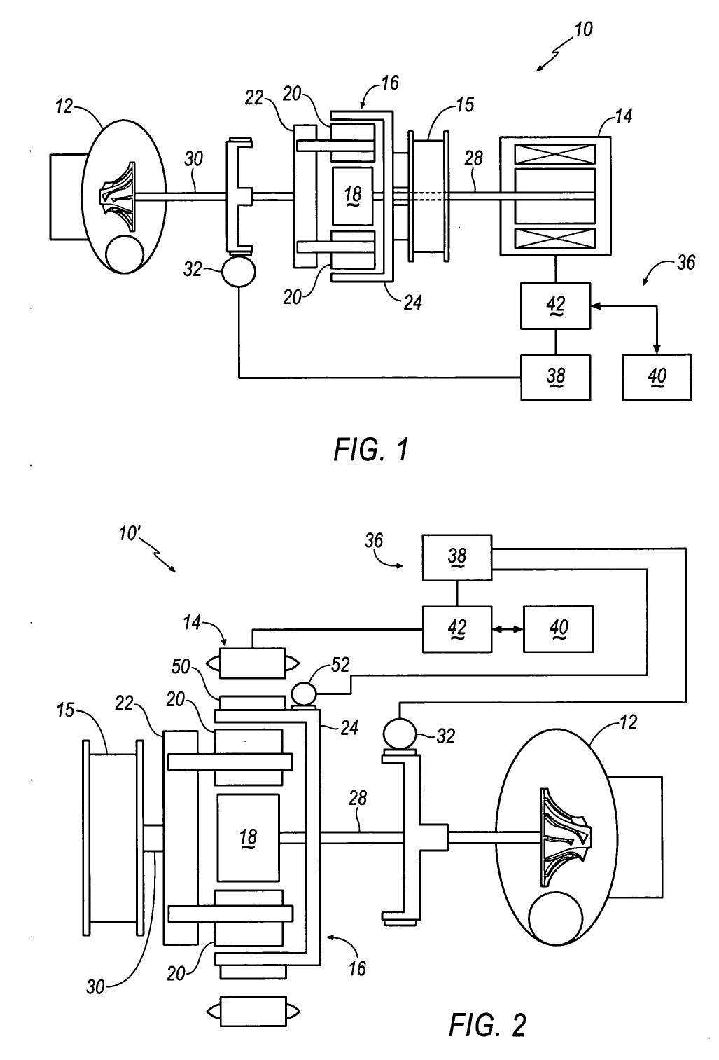

Referring to FIGS. 1 and 2, an engine supercharging system 10 according to embodiments of the present invention are shown. In the illustrated embodiments, supercharging system 10 includes an air pump 12, such as a centrifugal (shown), Roots-type, or screw-type supercharger; an electrical machine 14, such as an electric motor-generator; an engine-connected input member 15; and a variable-ratio power transmission mechanism 16. Power transmission mechanism 16 includes a sun member 18 operatively connected to one of air pump 12, electrical machine 14 and input member 15. At least one planet member 20 is drivingly interfaced with sun member 18 and rotatably carried by a carrier 22 operatively connected to another one of air pump 12, electrical machine 14 and input member 15. An annulus 24 is drivingly interfaced with the at least one planet member 20 and operatively connected to the other one of air pump 12, electrical machine 14 and input member 15.

In a particular configuration, power transmission mechanism 16 may be a traction-drive device that includes an elasto-hydrodynamic lubrication oil that creates a film between sun member 18, planet member 20 and annulus 24. The oil film exhibits a viscosity that is increasable under pressure created by the closely rotating components of the planetary system to transmit torque between sun member 18, planet member 20 and annulus 24. Compared to a conventional toothed-gear transmission, is capable of producing a relatively higher ratio while generating significantly less noise. In the embodiment shown in FIG. 1, for example, power transmission mechanism 16 is configured such that the speed ratio between first and second shafts 28, 30 is approximately fifteen-to-one (15:1); although, the speed ratio is not necessarily limited thereto. When a centrifugal supercharger is employed, for example, the ratio may be between about 10:1 and 20:1. It will also be appreciated that the interface between sun member 18, planetary member 20, and annulus 24 may be a geared interface, whereby torque is transmitted between the components by meshed gear teeth. When a Roots-type or screw-type supercharger is employed, for example, the speed ratio between first and second shafts 28, 30 may be between about 2:1 and 5:1.

Sun member 18 may operatively connected to one of air pump 12, electrical machine 14 and input member 15 by a first shaft 28 and carrier 22 may be operatively connected to another one of air pump 12, electrical machine 14 and input member 15 by a second shaft 30. A brake 32, such as a shaft brake, is configured to selectively inhibit rotation of sun member 18 or carrier 22 by virtue of its interaction with first shaft 28 or second shaft 30.

Engine-connected input member 15 may, for example, include a belt, gear or chain driven pulley that receives power from an engine by virtue of its connection to an engine crankshaft (none shown). In the embodiment shown in FIG. 1, for example, the speed ratio between engine-connected input member 15 and the engine crankshaft is approximately three-to-one (3:1) for a total ratio between the engine and the electrical machine of forty-five-to-one (45:1). However, the net speed ratio and the speed ratio between input member 15 and the engine crankshaft are not intended to be limited thereto.

Supercharging system 10 may also include a control system 36 having a controller 38, such as a microprocessor-based controller, which may communicate with and directs operation of electrical machine 14 and brake 32. Controller 38 may be a stand-alone component or may be integrated with another vehicle controller, such as the vehicle engine controller (not shown). If desired, an energy source 40, such as a battery, may be operatively connected to electrical machine 14 through a power converter 42, such as a two-quadrant inverter, to receive power from and/or supply power to electrical machine 14 for operation.

In the embodiment shown in FIG. 1, sun member 18 is operatively connected to electrical machine 14 through first shaft 28, annulus 24 is operatively connected to engine-connected input member 15 and carrier 22 is operatively connected to air pump 12 through second shaft 30. In a mode of operation, controller 38 is configured to activate brake 32 to inhibit rotation of carrier 22 and to operate electrical machine 14 as a motor to provide power to rotate sun member 18 and, by virtue of the corresponding rotation of planet member 20, annulus 24 and engine-connected input member 15 to provide torque to the vehicle engine. In this mode of operation, electrical machine 14 may be used to crank and start the vehicle engine, which may eliminate the need for a separate starter motor in the vehicle. Once the engine is started, controller 38 may continue to operate electrical machine 14 as a motor to deliver torque to the engine and adjoining powertrain. In this manner, supercharging system 10 may operate as a mild hybrid.

In another mode of operation, controller 38 is configured to deactivate brake 32 to permit rotation of carrier 22 and to inhibit rotation of sun member 18 using electrical machine 14 to permit torque flow from the engine-connected input member 15, through the power transmission mechanism 16, and into air pump 12. In this mode of operation, air pump 12 is powered solely by the engine crankshaft to deliver charged air to the engine.

In another mode of operation, controller 38 is configured to deactivate brake 32 to permit rotation of carrier 22 and to permit rotation of sun member 18 by operating electrical machine 14 as a generator. In this manner, torque flows from the engine-connected input member 15, through variable-ratio power transmission mechanism 16, and into the air pump 12. This mode of operation may be employed when less than full boost is required and allows a portion of the power provided by the engine to be returned to energy source 40. The amount of power returned to energy source 40 is generally equal to the generator operating speed multiplied by the torque reaction from air pump 12. For example, this power may be as high as 3 kW for 20 kW of mechanical boosting.

In certain vehicles into which supercharging system 10 maybe installed, the conventional alternator may be eliminated by operating electrical machine as a generator to provide power to the vehicle electrical system. When supercharging system 10 is being operated to provide charged air to “boost” the engine at a level other than full boost, power provided by the engine through input 15 is returned to energy source 40 by virtue of electrical machine 14 operating as a generator. When the vehicle is traveling on a highway, for example, and no “boost” is required, electrical machine 14 may be operated, as necessary, to more rapidly charge energy source 40 by applying brake 32. In an implementation of the invention, up to 10 kW of power may be available for generation and storage.

As noted above, there are several different compressor designs employable in supercharging system 10, but it is typically the centrifugal compressor, the same design as most turbochargers, that operatives more effectively when the engine is at full load. Unfortunately, in more traditional fixed-ratio supercharger drives, the centrifugal compressor delivers its boost roughly in proportion to the square of its rotational speed with very poor low speed torque augmentation. Since there is not necessarily a fixed link between the engine and air pump 12 in the present invention, air pump 12 may be run at its optimum speed. For example, in another operating mode, controller 38 may be configured to deactivate first brake 32 to permit rotation of carrier 22 and to rotate sun member 18 by operating electrical machine 14 as a motor to augment torque flow from the engine-connected input member 15, through the a variable-ratio power transmission mechanism 16, and into air pump 12. In this mode of operation, augmentation of low-end “boost” (i.e., when the engine speed is relatively low) may be obtained by using power from energy source 40 to power electrical machine 14 as a motor to increase the speed of air pump 12. This feature permits a vehicle manufacturer to adopt more efficient vehicle transmission ratios and creates a larger power/speed handling range to air pump 12 for a given peak power capability control system 36.

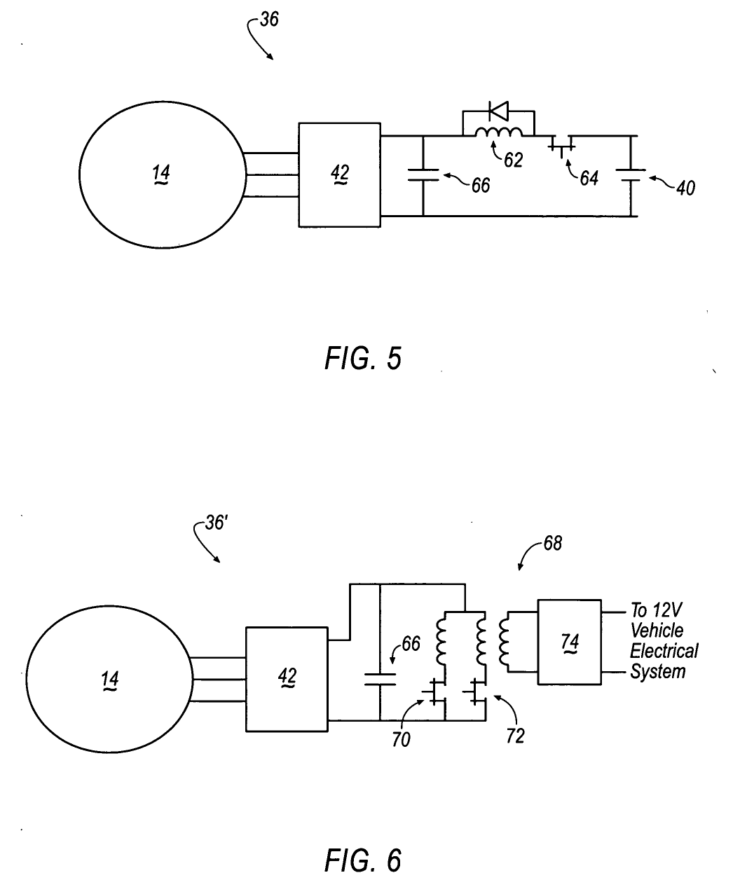

In the embodiment illustrated in FIG. 2, by contrast, sun member 18 is operatively connected to air pump 12 and electrical machine 14 is operatively connected to annulus 24, such as by integrating or connecting an electrical machine rotor 50 to annulus 24 for rotation therewith. Carrier 22 is operatively connected to engine-connected input member 15. In a mode of operation, controller 38 may be configured to activate brake 32 to inhibit rotation of sun member 18 and to operate electrical machine 14 as a motor to provide power to rotate annulus 24 and, by virtue of the corresponding rotation of planet member 20, to rotate carrier 22 and the engine-connected input member 15 to provide torque to the vehicle engine. In this mode of operation, electrical machine 14 may be used to crank and start the vehicle engine, which again may eliminate the need for a separate starter motor in the vehicle. Once the engine is started, controller 38 may continue to operate electrical machine 14 as a motor to provide torque to the engine and adjoining powertrain. In this manner, supercharging system 10′ may operate as a mild hybrid. When operation of supercharging system 10′ as a starter and mild hybrid are not desired, i.e., when only generator operation is desired, the two-quadrant motor inverter may be replaced with a less costly rectifier such as shown in FIGS. 5 and 6 and described below.

In another mode of operation, controller 38 is configured to activate brake 32 to inhibit rotation of sun member 18 and to permit rotation of annulus 24 by operating electrical machine 14 as a generator such that torque flows from engine-connected input member 15, through the a variable-ratio power transmission mechanism 16, and into the generator. Controller 38 may also be configured to deactivate brake 32 to permit rotation of sun member 18 and to inhibit or control rotation of annulus 24 using electrical machine 14 to permit torque from the engine-connected input member 15, through the power transmission mechanism 16, and into air pump 12. In this so-called “boosting” mode of operation, air pump 12 is powered by the engine crankshaft to deliver charged air to the engine.

In an exemplary implementation of the present invention, the required electrical power for driving air pump 12 with an efficiency of about 70% is approximately 12 kW, assuming a maximum engine speed of about 6000 RPM. As will be appreciated, the power requirement may depend on the required engine torque-speed curve and the efficiency may not be a steady 70% across the entire curve. Table I illustrates sample operating parameters for an exemplary implementation of the embodiment of FIG. 2 during the “boosting” mode of operation.

TABLE I

| | | | | Torque | | | | |
|---|---|---|---|---|---|---|---|---|
| | Input | Power | Sun | Applied | | Torque | Power | Required |
| Engine | Member | at Air | Member | to Sun | Annulus | Transmitted | Transmitted | Engine |
| Speed | Speed | Pump | Speed | Member | Speed | By Annulus | By Annulus | Power |
| (RPM) | (RPM) | (W) | (RPM) | (Nm) | (RPM) | (Nm) | (W) | (W) |
| 200 | 760 | 400 | 58590 | 0.07 | −3688 | 0.8 | −327 | 73 |
| 500 | 1900 | 1000 | 79276 | 0.12 | −4056 | 1.6 | −664 | 336 |
| 1000 | 3800 | 2000 | 99651 | 0.19 | −3573 | 2.5 | −932 | 1068 |
| 2000 | 7600 | 4000 | 125263 | 0.30 | −1451 | 4.0 | −602 | 3398 |
| 3000 | 11400 | 6000 | 143197 | 0.40 | 1262 | 5.2 | 687 | 6687 |
| 4000 | 15200 | 8000 | 157457 | 0.49 | 4257 | 6.3 | 2812 | 10812 |
| 5000 | 19000 | 10000 | 169489 | 0.56 | 7424 | 7.3 | 5694 | 15694 |
| 6000 | 28000 | 12000 | 180000 | 0.64 | 10708 | 8.3 | 9280 | 21280 |

In Table I, power at air pump 12 is the power required to drive the air pump for a constant pressure ratio. Sun member speed is the speed required for sun member 18 to generate the require amount of power at air pump 12. Power transmitted by annulus 24 is the power generated by electrical machine 14, whereby negative power denotes power flow from energy source 40 to annulus 24 (electrical machine 14 functioning as a motor) and positive power denotes power flow from annulus 24 to energy source 40 (electrical machine 14 functioning as a generator).

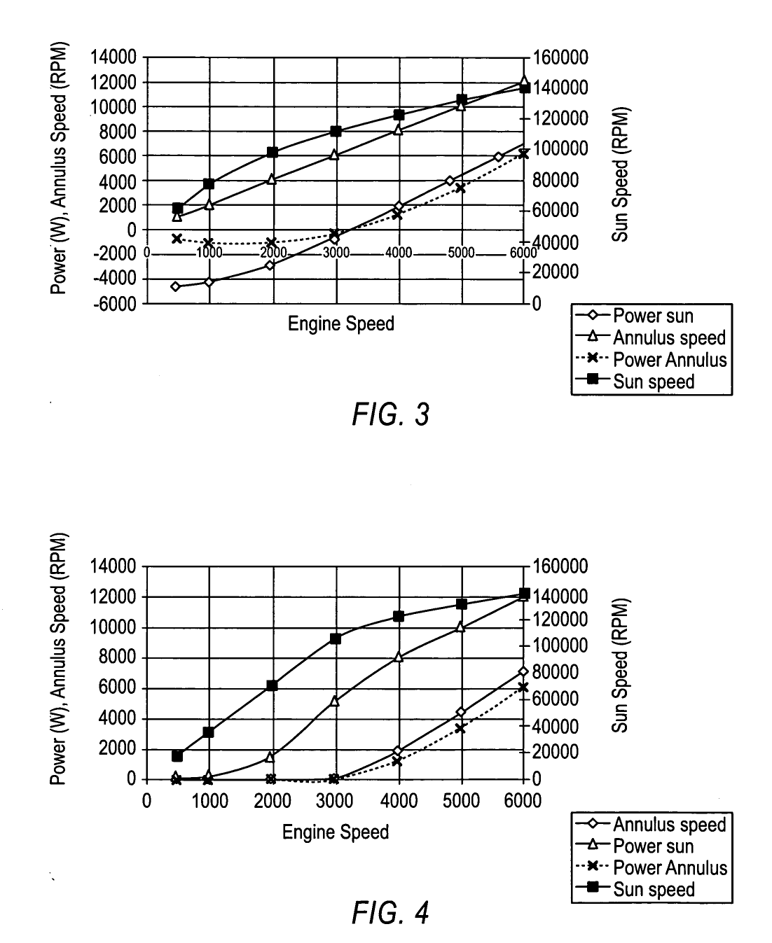

Referring to FIG. 3, several exemplary operating parameters presented in Table I are illustrated graphically. For nearly constant engine boost over the permissible speed range of an engine, power flows from energy source 40 through electrical machine 14 and into annulus 24 at engine speeds below about 2400 RPM. To accommodate this operation, electrical machine 14 may be configured, for example, as a brushless direct current motor utilizing power converter 42 to convert the direct current into three-phase alternating current.

In a mode of operation described above with respect to the embodiment of FIG. 2, rotation annulus 24 may be inhibited to provide reactionary torque to maximize the speed of sun member 18 and, correspondingly, the level of boost generated by air pump 12. Rotation of annulus 24 may be inhibited by virtue of brake 52 that selectively engages annulus 24, by shorting electrical machine 14, or by recovering power applied to annulus 24 in energy source 40. Table II illustrates sample operating parameters for another exemplary implementation of the embodiment of FIG. 2 during the “boosting” mode of operation.

TABLE II

| | | | | Torque | | | | |
|---|---|---|---|---|---|---|---|---|
| | Input | Sum | Sun | Applied | | Torque | Power | Required |
| Engine | Member | Member | Member | to Sun | Annulus | Transmitted | Transmitted | Engine |
| Speed | Speed | Speed | Power | Member | Speed | By Annulus | By Annulus | Power |
| (RPM) | (RPM) | (RPM) | (W) | (Nm) | (RPM) | (Nm) | (W) | (W) |
| 500 | 1600 | 17600 | 24 | 0.01 | 0 | 0.13 | 0 | 336 |
| 1000 | 3200 | 35200 | 191 | 0.05 | 0 | 0.52 | 0 | 1068 |
| 2000 | 6400 | 70400 | 1526 | 0.21 | 0 | 2.07 | 0 | 3398 |
| 3000 | 9600 | 105600 | 5150 | 0.47 | 0 | 4.66 | 0 | 6687 |
| 4000 | 12800 | 122300 | 8000 | 0.62 | 1850 | 6.25 | 1210 | 10812 |
| 5000 | 16000 | 131800 | 10013 | 0.73 | 4420 | 7.26 | 3358 | 15694 |
| 6000 | 19200 | 140000 | 12000 | 0.82 | 7120 | 8.19 | 6103 | 21280 |

Referring to FIG. 4, several exemplary operating parameters presented in Table II are illustrated graphically. For engine speeds up to about 3000 RPM, annulus is generally not rotating. A comparison of compressor power for the embodiments illustrated in FIGS. 1 and 2 is provided by way of example in the following table.

TABLE III

Compressor Power (W)

| Engine Speed (RPM) | Motor-Generator | Generator |
|---|---|---|
| 1000 | 2000 | 500 |
| 2000 | 4000 | 1700 |
| 3000 | 6000 | 5300 |

As shown in FIGS. 3 and 4, performance beyond about 3000 RPM is substantially similar for each exemplary implementation. The degree of performance degradation associated with generator-only operation below an engine speed of about 3000 RPM may be mitigated by increasing the effective ratio of power transmission mechanism 16.

To support generator-only operation, power converter 42 may include a rectifier (FIGS. 5 and 6), such as a six-diode bridge rectifier, which receives three-phase power from electrical machine 14 and converts this power into direct current. In the embodiment shown in FIG. 5, the rectifier may be electrically connected to energy source 40, with a line conductor 62 and field effect transistor (FET) 64 provided therebetween. Control system 36 may also include a capacitor 66.

At an engine speed of approximately 4000 RPM, for example, a sufficient electromotive force (EMF), e.g., around 15V, is required to push about 1210 W (see, e.g., Table II above) to energy source 40. Furthermore, as illustrated in Table II, an increasing amount of power must be pushed to energy source 40 as the engine speed increases, since it is generally undesirable to proportionately increase the speed of sun member 18. At about 6000 RPM, for example, the EMF increases to about 22.5V. Additionally, the current supplied to energy source 40 is controlled by running FET 64 in pulse width modulation (PWM) mode, with line conductor 62 and capacitor 66 facilitating this operation. In the described implementation, FET 64 may exhibit a maximum voltage rating of about 75V and a continuous mean current rating of about 271 A. If only half the power is required by air pump 12 at an engine speed of about 6000 RPM, for example, then FET 64 may exhibit a continuous mean current rating of about 135 A. A 3-5 kW electrical machine operating as a generator has an electrical output greater than many conventional vehicle alternators and, therefore, electrical machine 14 may be operated in a manner that allows the vehicle alternator to be eliminated.

Alternatively, control system 36 may include a second FET (not shown) that applies a dead short across the rectifier output (i.e., an eddy current brake). With a back EMF of about 15V, the second FET may be rated at about 60 A (75V). When no boost is required, the first and/or second FETs may be turn off, allowing annulus 24 to rotate freely and sun member 18 to find a conveniently slower rotational speed dependent on the amount of air being drawn into the engine.

Referring to FIG. 6, a control system 36′ according to another embodiment of the present invention is shown. Control system 36′ is similar to control system 36 described above with the addition of a switched-mode power supply 68 that performs current and voltage regulation on the high voltage side of the circuit. Power supply 68 may also be used to replace a conventional vehicle alternator. In an embodiment, power supply 68 includes a pair of switching FETs 70, 72 and a four-diode rectifier 74 communicating with the 12V vehicle electrical system. Assuming a mean voltage of about 300V for control system 36′, FETs 70, 72 may be rated at around 400V, 20 A and rectifier 74 may be rated at around 75V, 150 A (which can conveniently replace a 150 A alternator). Additionally, capacitor 66 may be configured as an ultra capacitor, allowing a reduction in the peak rating of the FETs under heavy boost and an averaging of the current being fed back to the 12V vehicle electrical system.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A supercharging system for an engine, comprising:
an air pump;
an electrical machine;
an engine-connected input member;
a variable-ratio power transmission mechanism including:
a sun member operatively connected to one of the air pump, the electrical
machine and the input member;
at least one planet member drivingly interfaced with the sun member and rotatably carried by a carrier operatively connected to another one of the air pump, the electrical machine and the input member; and
an annulus drivingly interfaced with the at least one planet member and operatively connected to the other one of the air pump, the electrical machine and the input member; and
a brake configured to selectively inhibit rotation of at least one of the sun member, the carrier, and the annulus.

2. The supercharging system of claim 1, wherein the air pump is one of a centrifugal, Roots-type and screw-type supercharger.

3. The supercharging system of claim 1, wherein the power transmission mechanism is a traction-drive device that includes an elasto-hydrodynamic lubrication oil that creates a film between the sun member, the planet member and the annulus, the oil film exhibiting a viscosity that is increasable under pressure to transmit torque between the sun member, the planet member and the annulus.

4. The supercharging system of claim 1, wherein the a sun member is operatively connected to one of the air pump, the electrical machine and the input member by a first shaft and the carrier is operatively connected to another one of the air pump, the electrical machine and the input member by a second shaft.

5. The supercharging system of claim 4, wherein the brake is configured to selectively inhibit rotation of the first or second shaft.

6. The supercharging system of claim 4, wherein the speed ratio between the first and second shafts is between approximately two-to-one and five-to-one, when the air-pump is one of a Roots-type and a screw-type supercharger, and between approximately ten-to-one and twenty-to-one when the air pump is a centrifugal supercharger.

7. The supercharging system of claim 1, wherein the speed ratio between the engine-connected input member and an engine crankshaft is approximately three to one.

8. The supercharging system of claim 1, further including a control system having a controller configured to operate the electrical machine and the brake.

9. The supercharging system of claim 8, wherein the sun member is operatively connected to the electrical machine, the annulus is operatively connected to the engine-connected input member and the carrier is operatively connected to the air pump, and wherein the controller is configured to activate the brake to inhibit rotation of the carrier and to operate the electrical machine as a motor to provide power to rotate the sun member and, by virtue of the corresponding rotation of the at least one planet member, to rotate the annulus and the engine-connected input member to provide torque to the engine.

10. The supercharging system of claim 8, wherein the sun member is operatively connected to the electrical machine, the annulus is operatively connected to the engine-connected input member and the carrier is operatively connected to the air pump, and wherein the controller is configured to deactivate the brake to permit rotation of the carrier and to control or inhibit rotation of the sun member by operating the electrical machine as a generator to permit torque flow from the engine-connected input member, through the variable-ratio power transmission mechanism, and into the air pump.

11. The supercharging system of claim 8, wherein the sun member is operatively connected to the electrical machine, the annulus is operatively connected to the engine-connected input member and the carrier is operatively connected to the air pump, and wherein the controller is configured to deactivate the brake to permit rotation of the carrier and to rotate the sun member by operating electrical machine as a motor to augment torque flow from the engine-connected input member, through the variable-ratio power transmission mechanism, and into the air pump.

12. The supercharging system of claim 8, wherein the sun member is operatively connected to the air pump, the annulus is operatively connected to the electrical machine and the carrier is operatively connected to the engine-connected input member, and wherein the controller is configured to activate the brake to inhibit rotation of the sun member and to operate the electrical machine as a motor to provide power to rotate the annulus and, by virtue of the corresponding rotation of the planet member, to rotate the carrier and the engine-connected input member to provide torque to the engine.

13. The supercharging system of claim 8, wherein the sun member is operatively connected to the air pump, the annulus is operatively connected to the electrical machine and the carrier is operatively connected to the engine-connected input member, and wherein the controller is configured to activate brake to inhibit rotation of the sun member and to permit rotation of the annulus by operating the electrical machine as a generator such that torque flows from the engine-connected input member, through the variable-ratio power transmission mechanism, and into the generator.

14. The supercharging system of claim 8, wherein the sun member is operatively connected to the air pump, the annulus is operatively connected to the electrical machine and the carrier is operatively connected to the engine-connected input member, and wherein the controller is configured to deactivate the brake to permit rotation of the sun member and to control or inhibit rotation of the annulus using the electrical machine to permit torque flow from the engine-connected input member, through the power transmission mechanism, and into the air pump.

15. The supercharging system of claim 8, wherein the control system further includes an energy source operatively connected to the electrical machine through a power converter.

16. The supercharging system of claim 15, wherein the power converter includes a rectifier electrically connected to the energy source and the control system further includes a line conductor, a field effect transistor (FET) and a capacitor.

17. The supercharging system of claim 16, wherein the control system includes a second field effect transistor (FET) that applies a dead short across an output of the rectifier.

18. The supercharging system of claim 15, wherein the control system includes a power supply having a pair of switching field effect transistors (FETs) and a rectifier connected to a 12V vehicle electrical system.

19. A supercharging system for an engine, comprising:
an air pump;
an electrical machine;
an engine-connected input member;
a variable-ratio power transmission mechanism including:
a sun member operatively connected to the electrical machine;
at least one planet member drivingly interfaced with the sun member and rotatably carried by a carrier operatively connected to the air pump; and
an annulus drivingly interfaced with the at least one planet member and operatively connected to the input member; and
a brake configured to selectively inhibit rotation of the carrier.

20. A supercharging system for an engine, comprising:
an air pump;
an electrical machine;
an engine-connected input member;
a variable-ratio power transmission mechanism including:
a sun member operatively connected to the air pump;
at least one planet member drivingly interfaced with the sun member and rotatably carried by a carrier operatively connected to the input member; and
an annulus drivingly interfaced with the at least one planet member and operatively connected to the electrical machine; and
a brake configured to selectively inhibit rotation of at least one of the sun member and the annulus.
